(19) United States
(12) Patent Application Publication
(10) Pub. No.: US 2013/0100772 A1
(43) Pub. Date: Apr. 25, 2013

(54) Seismic Data Acquisition Array and Corresponding Method

(71) Applicants: Kirk Girouard, Houston, TX (US); Richard Degner, Bellaire, TX (US); Thomas John Fleure, Missouri City, TX (US); David Martin Flentge, Sugar Land, TX (US)

(72) Inventors: Kirk Girouard, Houston, TX (US); Richard Degner, Bellaire, TX (US); Thomas John Fleure, Missouri City, TX (US); David Martin Flentge, Sugar Land, TX (US)

(73) Assignee: Global Geophysical Services, Inc., Missouri City, TX (US)

(21) Appl. No.: 13/277,181

(22) Filed: Oct. 19, 2011

(51) Int. Cl. G01V 1/20

(52) U.S. Cl. 367/56

(57) ABSTRACT

Disclosed are various embodiments of methods and systems for a 3D seismic data acquisition array, comprising: a first plurality of receiver positions, substantially equally spaced along a first plurality of substantially parallel and substantially equally spaced receiver lines; a second plurality of receiver positions, substantially equally spaced along a second plurality of substantially parallel and substantially equally spaced receiver lines, wherein the receiver lines in the second plurality of receiver lines are substantially orthogonal to the receiver lines in the first plurality of receiver lines; a plurality of source positions, the source positions being located along a plurality of substantially parallel and substantially equally spaced source lines that are substantially parallel to one of the diagonals of the rectangles formed by the first plurality of receiver lines and the second plurality of receiver lines.

### FIELD

Various embodiments described herein relate to the field of seismic data acquisition and/or processing, and devices, systems and methods associated therewith.

### BACKGROUND

Seismic surveying for oil and gas reserves is performed by setting out seismic receivers in an area of interest, then creating seismic waves using a variety of seismic sources. The receivers pick up the seismic waves and convert the seismic energy to electrical signals which are digitized and processed through computer systems to create an image of the subsurface.

The design of a seismic survey should meet several objectives. One of the most important objective is the degree of subsurface coverage provided by the chosen design. Subsurface coverage is measured as the number of seismic source and receiver combinations which correspond to a given common midpoint between the source and receiver positions, a value referred to as the “fold” of the data. Another design objective is ensuring that for any common midpoint, the seismic traces have a suitable range of offset values to enable the calculation of the velocity at which the seismic energy travels through the geological formations. The distribution of offset values also determines the effectiveness of noise cancellation techniques. Other design criteria include the area or volume of the subsurface to be imaged, the maximum depth from which usable data may be expected, and the maximum frequency of the seismic data.

Efficiency and cost also influence the design of the array used for the seismic survey. The data should be acquired with a minimum number of source and receiver positions required to produce the subsurface coverage without redundancy. There are costs involved in setting the receivers in place, and in retrieving them when the survey is complete. If an explosive seismic source is used, there are additional costs for drilling holes for the explosive charges. Brush clearing may be necessary for vehicles and equipment access. There are costs for remediation after explosives have been used, and also for tracks made by vehicles. The design of the array must also take into account factors such as limited seasonal access, proximity to buildings, wells, and other sources of noise.

What is required is a way of acquiring 3-D seismic data which provides consistent and sufficient coverage of the subsurface, while making the best use of the available receivers and minimizing the number of source positions required to complete the survey.

### SUMMARY

In one embodiment, there is provided a 3D seismic data acquisition array, comprising a plurality of source positions, the source positions being located along a plurality of source lines, the source lines being substantially parallel to one another; a first plurality of receiver positions, the first plurality of receiver positions being substantially equally spaced at a first receiver spacing along a first plurality of receiver lines, the first plurality of receiver lines being substantially parallel to one another and substantially equally spaced from one another at a first receiver line spacing; a second plurality of receiver positions, the second plurality of receiver positions being substantially equally spaced at a second receiver spacing along a second plurality of receiver lines, the second plurality of receiver lines being substantially parallel to one another and substantially equally spaced from one another at a second receiver line spacing; wherein the receiver lines in the second plurality of receiver lines are substantially orthogonal to the receiver lines in the first plurality of receiver lines, and the plurality of source lines are substantially parallel to one of the diagonals of the rectangles formed by the first plurality of receiver lines and the second plurality of receiver lines.

In another embodiment, there is provided a method of performing a seismic survey, comprising: generating seismic signals at a plurality of source positions, the source positions being located along a plurality of source lines, the source lines being substantially parallel to one another; detecting the seismic signals at a first plurality of receiver positions, the first plurality of receiver positions being substantially equally spaced at a first receiver spacing along a first plurality of receiver lines, the first plurality of receiver lines being substantially parallel to one another and substantially equally spaced from one another at a first receiver line spacing; detecting the seismic signals at a second plurality of receiver positions, the second plurality of receiver positions being substantially equally spaced at a second receiver spacing along a second plurality of receiver lines, the second plurality of receiver lines being substantially parallel to one another and substantially equally spaced from one another at a second receiver line spacing; wherein the receiver lines in the second plurality of receiver lines are substantially orthogonal to the receiver lines in the first plurality of receiver lines, and the plurality of source lines are substantially parallel to one of the diagonals of the rectangles formed by the first plurality of receiver lines and the second plurality of receiver lines.

In yet another embodiment, there is provided a method of performing a seismic survey, comprising: generating seismic signals at a first plurality of source positions, the source positions being located along a first plurality of source lines at a first source position spacing, the source lines being substantially parallel to one another and substantially equally spaced from one another at a first source line spacing; generating seismic signals at a second plurality of source positions, the source positions being located along a second plurality of source lines at a second source position spacing, the source lines being substantially parallel to one another and substantially equally spaced from one another at a second source line spacing, the source lines in the second plurality of source lines being substantially orthogonal to the source lines in the first plurality of source lines; detecting the seismic signals at a plurality of receiver positions, the receiver positions being substantially equally spaced at a receiver spacing along a plurality of receiver lines, the plurality of receiver lines being substantially parallel to one another and substantially equally spaced from one another at a first receiver line spacing, and the plurality of receiver lines being substantially parallel to one of the diagonals of the rectangles formed by the first plurality of source lines and the second plurality of source lines.

### BRIEF DESCRIPTION OF THE DRAWINGS

Different aspects of the various embodiments of the invention will become apparent from the following specification, drawings and claims in which:

FIG. 1 shows one embodiment of a cross-sectional view of the earth and corresponding data acquisition, recording and analysis system 10;

FIG. 2 shows one embodiment of a cross-sectional view of the earth and corresponding seismic energy paths 50 from one source position 32 into a plurality of receiver positions 42, 44, 46, 48;

FIG. 3 shows one embodiment of a cross-sectional view of the earth and corresponding seismic energy paths 50 from a plurality of source positions 32, 34, 36, 38 into a plurality of receiver positions 42, 44, 46, 48, sorted by common midpoint 86;

FIG. 4 shows one embodiment of a method of acquiring 3-dimensional seismic data using orthogonal seismic source and receiver lines;

FIGS. 5(a) through 5(d) show the common midpoints corresponding to one embodiment of a method of acquiring 3-dimensional seismic data using orthogonal seismic source and receiver lines;

FIGS. 6(a) and 6(b) show two embodiments of a method of acquiring 3-dimensional seismic data using orthogonal seismic source and receiver lines;

FIG. 7 shows one embodiment of a method of acquiring 3-dimensional seismic data using mutually orthogonal seismic receiver lines;

FIGS. 8(a) and 8(b) show two embodiments of a method of acquiring 3-dimensional seismic data using mutually orthogonal seismic receiver lines and diagonal seismic source lines;

FIGS. 9(a) through 9(c) show a plot of the geometry and fold for one embodiment of a method of acquiring 3-dimensional seismic data using orthogonal seismic source and receiver lines;

FIGS. 10(a) through 10(c) show shows a plot of the geometry and fold for another embodiment of a method of acquiring 3-dimensional seismic data using orthogonal seismic source and receiver lines, and

FIGS. 11(a) through 11(c) show a plot of the geometry and fold for one embodiment of a method of acquiring 3-dimensional seismic data using orthogonal receiver lines and a diagonal source line.

The drawings are not necessarily to scale. Like numbers refer to like parts or steps throughout the drawings, unless otherwise noted.

### DETAILED DESCRIPTIONS OF SOME EMBODIMENTS

In the following description, specific details are provided to impart a thorough understanding of the various embodiments of the invention. Upon having read and understood the specification, claims and drawings hereof, however, those skilled in the art will understand that some embodiments of the invention may be practiced without hewing to some of the specific details set forth herein. Moreover, to avoid obscuring the invention, some well known methods, processes and devices and systems finding application in the various embodiments described herein are not disclosed in detail.

In the drawings, some, but not all, possible embodiments are illustrated, and further may not be shown to scale.

Some of the drawings and descriptions thereof are provided as examples of simplified data acquisition geometries to assist the reader in understanding the concepts of seismic data acquisition, and are not to be taken as limitations on the present method, devices and systems.

In earthquake seismology, sensitive listening devices are used to detect the energy released by earthquakes. Scientists can study the deeper layers of the subsurface of the earth in detail as the energy from powerful but distant earthquakes travels through the earth. During World War I, seismic monitoring devices were adapted and used to pinpoint the location of heavy artillery guns, which sent energy, in the form of seismic waves or sound waves, into the earth as they fired. In the years following, the techniques developed for this purpose found a new application as seismic exploration for oil and gas began to produce significant useful information.

Oil and gas exploration and other applications of modern seismic techniques do not rely on distant sources, or seismic waves traveling through the deeper layers of the earth's crust. Instead “reflection seismology” is used to obtain images of the geologic layers from the surface down to depths of thousands of feet. Controlled seismic sources are used to generate signals which are transmitted through the geologic formations in the subsurface of the earth. Changes in the properties of the rocks in these geologic formations result in the seismic energy being partially reflected back to the surface, where it is detected using listening devices known as geophones. The seismic energy travels through the different geologic formations at different velocities, and changes in velocity at interfaces between geologic formations results in reflected energy. The seismic data are recorded in a digital format and then processed through various software programs to produce maps, 3-dimensional displays of the geologic formations, and other information about the properties of the subsurface of the earth.

The seismic sources used for surveying on land may be explosive charges, usually buried in shallow holes drilled for the purpose, or the seismic survey team may use seismic vibrators, which are large trucks configured to send vibratory signals of known and varying frequencies into the earth. Various other sources are also used, but are less common. Ideally, seismic sources are activated at locations arranged in a regular pattern. In reality, there are numerous reasons why the actual locations used differ from the ideal. These include terrain, obstacles such as buildings, streams, ponds and lakes, oilfield equipment, crops, etc. Other obstacles, may be just as important to avoid, such as water wells, producing oil wells, buried pipelines, and more. Landowners may refuse to provide access to their land for seismic survey equipment, or may refuse to permit the use of explosive sources. Usually the seismic sources can be activated in locations at or close to the desired location, but sometimes some locations must be omitted from a survey. The use of explosive sources is expensive. The use of seismic vibrators is not as expensive per activation, but is capital intensive and must be carried out as efficiently as possible.

Seismic exploration is also carried out at sea or other marine or lacustrine using a sensor sometimes referred to as a “hydrophone”. Both hydrophones and geophones, and other types of sensor such as accelerometers, are normally referred to as “receivers”. Because the seismic energy reflected back to the surface is weak, to provide some signal enhancement, and to reduce the effects of noise, it is common to connect multiple geophones together. In land seismic exploration the individual geophones are placed on the surface of the earth some short distance apart, centered about a position referred to as a “receiver station” or “station”. The geophones may be connected by cables to the receiver station, and the receiver stations may also be connected by cables. The same obstacles listed for the source positions may also impact the positioning of the receiver stations with the added complexity of having to make sure that the cables, which may remain in place for some time, are not damaged by traffic, farm machinery, oilfield machinery, and other hazards. In recent years the trend has been towards the use of wireless receiver stations, which either transmit the data in real time to a central data collection point, or store the data on a memory device for collection later. Wireless receiver stations offer more flexibility in the field, but bring their own set of logistical issues including the need for power, often provided by rechargeable batteries.

A seismic survey is conducted by setting out geophones in a predetermined pattern, and then recording data from these geophones during each activation of a seismic source. An activation of a seismic source is usually referred to as a “shot”, regardless of the type of seismic source. The geophones convert the seismic energy into an electrical signal, or sometimes an optical signal, which is recorded for analysis. The data are recorded in digital format as a series of values representing the seismic energy. For an explosive source, recording may be done for about two seconds to about twenty seconds after the detonation of the source. A vibratory source sends a signal into the ground, usually starting at one frequency and “sweeping” through a range of frequencies to another frequency. For this type of source, the recording begins as the frequency sweep is initiated and continues for about two seconds to about twenty seconds after the frequency sweep completes. The data recording equipment has multiple channels to allow simultaneous recording from multiple receiver positions. The time series recorded for each receiver station for each shot is referred to as a “trace”.

The range of frequencies used in seismic exploration generally falls within the range of 8-120 Hz. The rate at which data are recorded for each of the channels corresponding to each of the sensors may also be varied in accordance with the objectives of the survey, the frequencies characteristic of the seismic energy generated by the seismic source, and the predicted attenuation of the seismic wavefront as it propagates through the subsurface. For example, if frequencies less than or equal to 125 Hz are expected to be sensed or measured, data may be sampled at a rate of 4.0 milliseconds (“ms”) per channel to ensure aliasing does not occur. Other sample rates are also possible such as 0.25 ms, 0.5 ms, 1 ms, 2 ms, 8 ms, 16 ms, and so on.

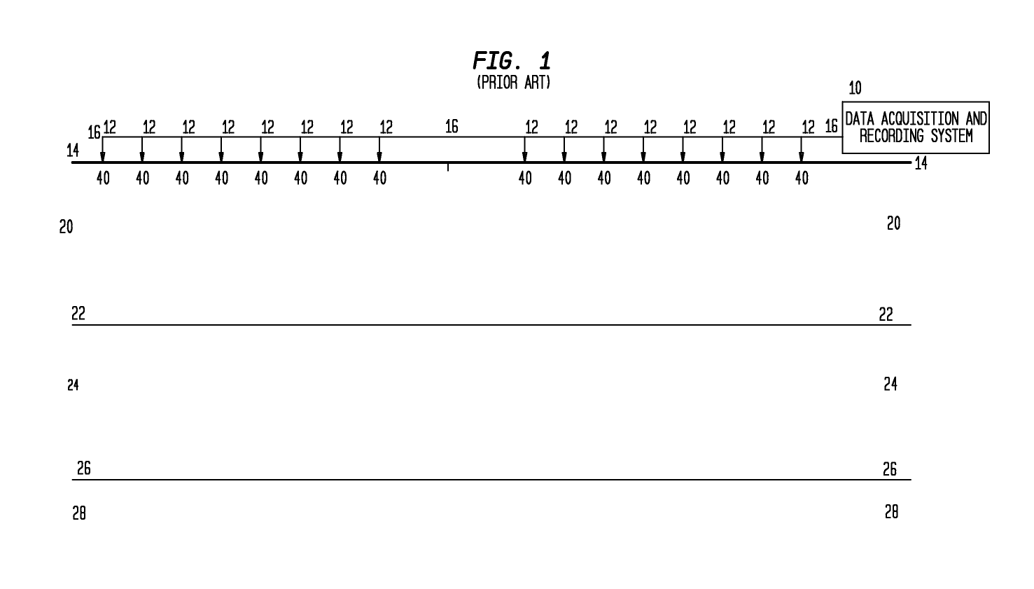

In the early days of land based seismic exploration, receivers were set out in a straight line, and the source positions closely followed the same line. An example of this approach is shown in FIG. 1. Energy from a seismic source reflects from the interfaces between the geologic layers into multiple receiver positions. Using techniques well known in the art, the collected data are sorted by collecting seismic traces with a source position and a receiver position symmetrically located about a common midpoint. Reflection travel times for these common midpoint sorted data vary according to increasing “offset”, that is, source(x, y)−receiver(x, y). Using techniques well known in the art, corrections for this travel time difference are applied, and the traces summed or “stacked” to enhance the level of the signal and reduce noise.

FIG. 1 shows an embodiment of a simple configuration of a land seismic survey. A plurality of receivers 12 are positioned at a plurality of receiver stations 40 located proximate surface of the earth 14. In some embodiments receivers 12 are placed on surface of the earth 14, and in other embodiments receivers 12 may be buried or placed in holes drilled for the purpose in order to reduce ambient noise. Each of receivers 12 may comprise one sensor or a plurality of sensors, or arrays of sensors, and are typically geophones, although accelerometers and other types of electrical, magnetic and optical sensors may also be used. Note further that according to various embodiments, receivers 12 may be single axis sensors, 2- or 3-mutually-orthogonal axis sensors, geophones, hydrophones or accelerometers configured to generate electrical, magnetic and/or optical signals proportional to the displacement, velocity or acceleration of the earth at receiver stations 40 corresponding to receivers 12 where such displacement, velocity or acceleration is caused by seismic wavefront arriving at the locations of receivers 12. Seismic energy detected by receivers 12 at the plurality of receiver stations 40 is converted to an electrical signal and the electrical signal is transmitted to data acquisition and recording system 10. In some embodiments the electrical signal is transmitted by cable 16. In other embodiments the signal is transmitted by a radio transmitter at each receiver station 40 to data acquisition and recording system 10. In yet other embodiments the electrical signal is stored at each receiver station 40 in a memory device and the stored data are collected periodically and loaded into data acquisition and recording system 10. Geologic formations 20, 24, and 28 within the subsurface of the earth have interfaces at 22, 24, where the properties of the rocks in the geologic formations changes.

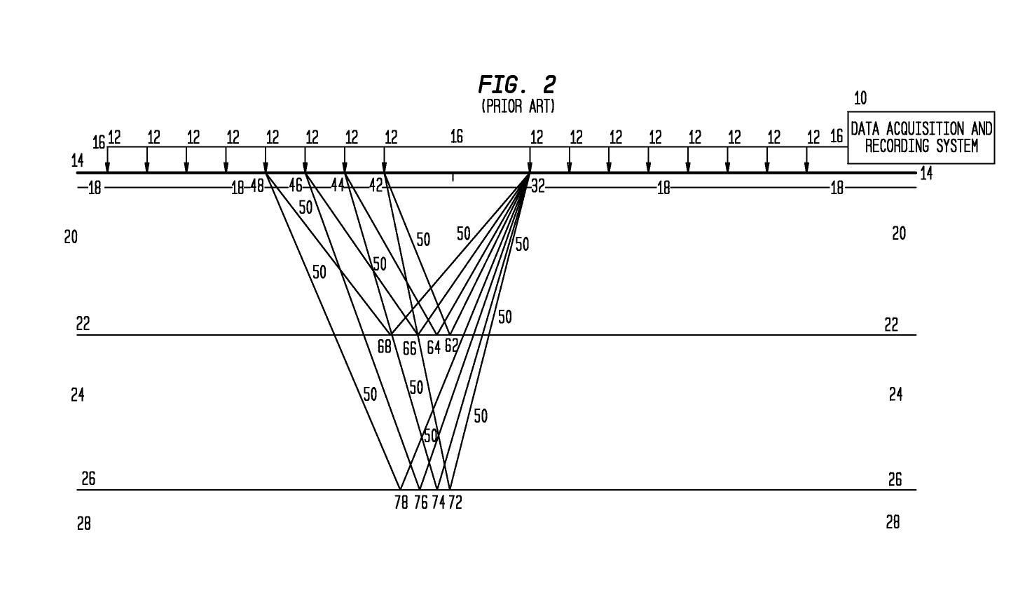

Referring now to FIG. 2, seismic source 32 proximate surface of the earth 14 sends seismic energy 50 into geologic formations 20, 24, and 28 in the subsurface of the earth. In some embodiments, such as vibratory sources, seismic source 32 may be on surface of the earth 14. In other embodiments employing explosive sources, seismic source 32 may be proximate surface of the earth 14 in a hole drilled for the purpose to ensure more efficient transmission of seismic energy 50 into the subsurface. In some embodiments, placing seismic source 32 a short distance below the surface is done to ensure that seismic source 32 is below “weathering layer” 18, that is, the unconsolidated layers at surface of the earth 14 which may be loose soil, eroded or deposited materials, and so on, which do not transmit seismic energy 50 effectively.

Still referring to FIG. 2, seismic energy 50 is reflected from interfaces 22 and 26 of geologic formations 20, 24, and 28 at reflection points 62, 64, 66, 68, 72, 74, 76 and 78, and is detected at receiver stations 42, 44, 46 and 48. Assuming that interfaces 22 and 26 of the geologic formations are horizontal, reflection points 62, 64, 66, 68, 72, 74, 76 and 78 correspond to the midpoints between source 32 and respective receiver stations 42, 44, 46, and 48. For example, for source 32 and receiver station 42, the corresponding reflection point at interface 22 is 62 and for interface 26, the corresponding reflection point is 72. Each shot results in the recording of seismic traces at a plurality of receiver stations 12 with a plurality of different reflection points. The seismic traces recorded at a plurality of receiver stations 12 from one shot are referred to as a “shot record”. As a seismic survey progresses, each receiver station 12 detects seismic energy 50 from a plurality of shots, with different reflection points, the corresponding seismic traces being distributed across a plurality of shot records.

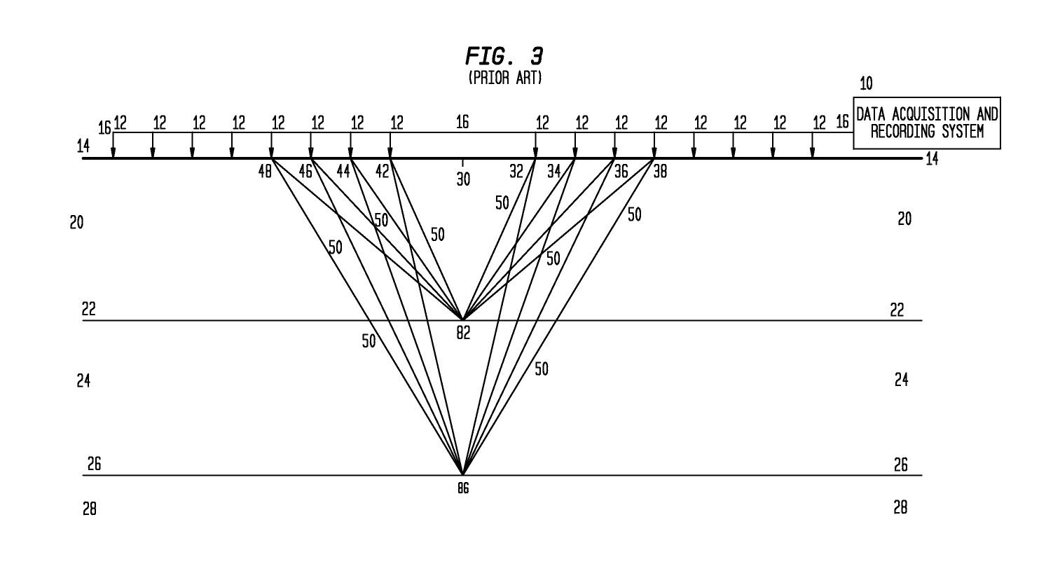

Referring now to FIG. 3, there is shown the principle of the common midpoint. It is not easy to interpret seismic data in shot record format. In order to image reflection points in the subsurface, techniques well known in the art are employed to sort the data into a more useful format. These techniques collect all of the seismic traces which correspond to a vertical set of reflection points in the subsurface. As shown in FIG. 3, a coincident shot and receiver at a given surface location 30 ideally image the geologic interfaces at points 82 and 86, directly below coincident source position and receiver position 30. These same points 82 and 86 in the subsurface are also imaged by a shot at source position 32 on one side of the given surface location, and receiver 12 at receiver position 42 symmetrically positioned on the other side of the given surface location. These same points 82 and 86 in the subsurface are also imaged by a shot at source position 34 on one side of the given surface location 30, and receiver 12 at receiver position 44 symmetrically positioned on the other side of surface location 30. Surface location 30 about which the source and receiver positions are centered is known as the “common midpoint” and the distance from the source position to the receiver position is called the “offset”. In some embodiments there may be a reciprocal pair of shot and receiver positions, with the shot and receiver positions interchanged, depending on the source and receiver position spacing. Consider a shot at source position 42, the seismic energy from which is reflected at reflection points 62 and 72 and is recorded at a receiver station at receiver position 32. In some embodiments there is a shot at source position 32 which is recorded at a receiver station at receiver position 42. As more shots are recorded, as shown at 32-42, 34-44, 36-46 and 38-48, there are more shot-receiver pairs centered on the common midpoint 30. The seismic traces corresponding to shot-receiver pairs centered on common midpoint 30 are sorted, or “gathered”, and the process repeated for all common midpoints to produce common midpoint “gathers” of seismic traces.

The path the seismic energy takes is not vertical for the data within gathers having non-zero offsets. The greater the offset, the more the path deviates from the vertical, and the greater the time taken for seismic energy 50 from the source to reach the receiver. In conventional seismic processing, data recorded at common midpoint 30 is corrected for such travel time differences and summed or “stacked” to produce the equivalent of the data which would have been recorded by a coincident shot and receiver at the mid-point 30. This process includes computing the velocity of seismic energy 50 through each of geologic formations 20, 24 and 28, using the differences in the travel times for seismic traces with different offsets and applying corrections based on the travel times and velocities.

The process of stacking helps to address another problem with land seismic data known as “ground roll”. This is seismic energy transmitted directly from the source to the receiver in the form of a wave traveling along surface of the earth 14. Some of this seismic energy is attenuated by the stacking process because the different offsets of the seismic traces with a common midpoint gather results in seismic energy appearing on different traces at different times and thus tends to cancel out. Other techniques for removing the effects of unwanted seismic energy from the seismic traces, such as frequency-wave number filtering, are well known to those skilled in the art.

Still referring to FIG. 3, in order for the techniques described above to work correctly, the source positions and receiver positions must be substantially regular in their spatial locations. This ensures that there is a plurality of seismic traces at a each of a reasonable number of common midpoints. One of the major considerations in the design of a seismic survey is the spatial distribution of the common midpoints, and the number of seismic traces which correspond to each of those midpoints, a number which is referred to as the “fold” of the seismic survey. In the 2-dimensional embodiment shown, the common midpoint spacing and the fold can be quickly computed from the spacing of the source positions and the spacing of the receiver positions. The common midpoint spacing used for a seismic survey determines the resolution of the detail which can be seen in the final display of the seismic data. In 3-dimensional embodiments and to allow for small variations in source position and receiver position which may be caused by terrain, obstacles, and other reasons for not placing the shots and receivers exactly at the surveyed source and receiver positions, the seismic traces are allocated to “bins” with a chosen spatial dimension rather than to exact common midpoints.

Still referring to FIG. 3, many early seismic surveys were performed by acquiring data along a series of coincident source and receiver lines, each of which would image a slice of the subsurface of the earth below the source and receiver line. One seismic line is generally insufficient to map an area, and therefore multiple shot and receiver lines are typically used within an area of interest, so that the image of the subsurface can be built up piece by piece. As a result seismic surveys typically consisted of a plurality of lines of varying lengths and at various orientations designed to cover the area of interest in the subsurface. Often the lines were arranged approximately in a grid, centered over a potential hydrocarbon reservoir.

Reflected seismic energy does not all come from directly below source-receiver lines because geologic formations are not horizontal. Formations slope at various angles and additionally contain faults and fractures, which also reflect seismic energy. When the data are processed and displayed as a geologic cross-section of the earth, much of the energy seen on the display is from reflections originating out of the vertical plane of the cross-section. Even within the plane, tilted geologic interfaces and faults appear in locations other than where they should be. Interpreting the results of a seismic survey and creating a 3-dimensional understanding of the subsurface from 2-dimensional data requires considerable skill. To overcome these problems, seismic exploration companies began to develop techniques to conduct 3-dimensional seismic surveys.

As recording equipment capable of handling more data channels became available, 3-D seismic surveys became possible, and eventually the norm. 3-D surveys use arrays of receiver stations, often laid out as very long (e.g. 3-5 kilometer) multiple parallel lines of receivers. If multiple receiver lines are to be laid out in order to acquire data from multiple shot-receiver lines, it makes sense to place all the receivers and then record the data from all the receiver lines regardless of the shot position. This approach may be limited by economic considerations (as it requires a large number of geophones) and by limitations of the data recording equipment, which may be limited in the number of available data channels, and hence is limited to recording from a subset of the geophones for any given shot. This subset is referred to as the “recording patch”. In many surveys, even when wireless geophones are used, the receivers are still placed in parallel lines in order to maintain a constant and predictable coverage of the subsurface and facilitate the placement of the receivers by the survey team. This requires more complex surveying, but the availability of inexpensive GPS technology means that the wireless geophone stations can now record their geographic coordinates along with the seismic data they are receiving.

Some other arrays used or proposed for seismic data acquisition are described in FIG. 1 of the paper “3-D symmetric sampling” by Gijs J. O Vermeer, Geophysics, Vol. 63, No. 5, 1998, P. 1631, which is incorporated herein by reference in its entirety, hereafter “the Vermeer reference”. The Vermeer reference shows various methods which were developed and used to obtain seismic data in a 3-dimensional format. FIG. 1(a) of the Vermeer reference shows an areal array. FIG. 1(b) thereof shows an orthogonal geometry (using the older definition of “orthogonal” as widely spaced parallel source lines perpendicular to widely spaced parallel receiver lines.) FIG. 1(c) of the Vermeer reference shows a zigzag geometry, in which two families of widely spaced parallel source lines are aligned at angles to widely spaced parallel receiver lines. FIG. 1(d) of the Vermeer reference illustrates an example of a parallel geometry, wherein both source lines and receiver lines are parallel to one another.

Another configuration using a set of parallel receiver lines, with source lines arranged on a diagonal to the direction of the receiver lines is described in U.S. Pat. No. 5,511,039, entitled “Method of performing high resolution crossed-array seismic surveys” to Flentge, and in U.S. Pat. No. 5,598,378, entitled “Method of performing high resolution crossed-array seismic surveys”, to Flentge, both of which are hereby incorporated herein by reference in their respective entireties.

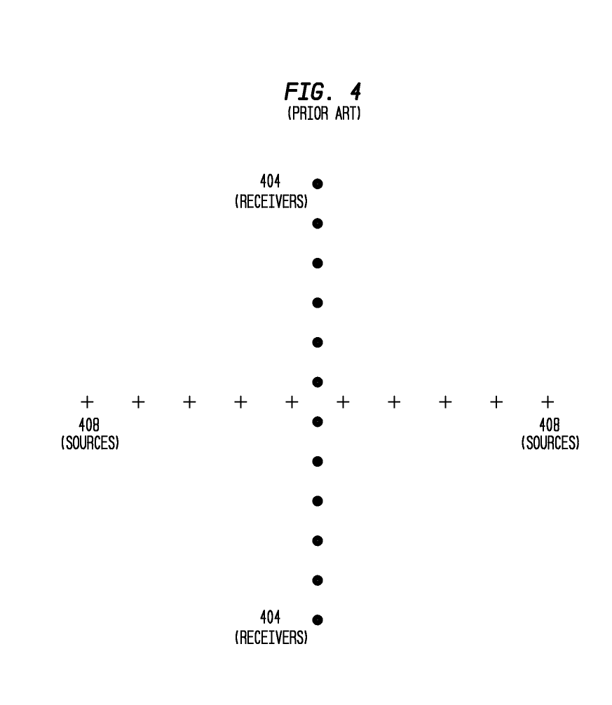

Referring now to FIG. 4, shown here is a simple array with receiver line 404 and source line 408 shown, as seen from directly above. Because source line 408 is orthogonal to receiver line 404, this geometry is often referred to as an “orthogonal array”.

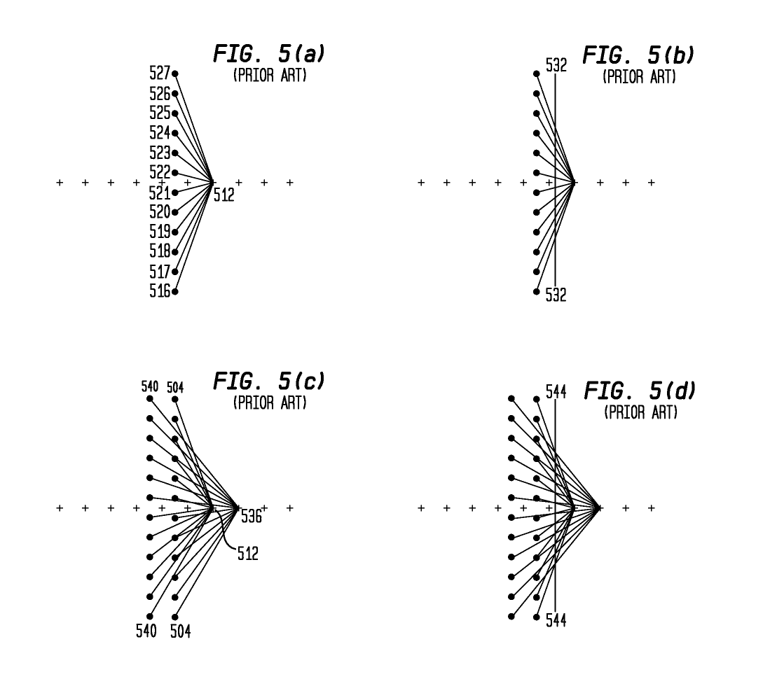

FIG. 5(a) shows seismic energy 50 from shot 512 on source line 408 being received at a plurality of receiver stations 516 through 527, on receiver line 404. FIG. 5(b) adds line 532 to show the position of the common midpoints for this combination of source and receiver positions. FIG. 5(c) shows the seismic energy from two shots 512 and 536 into two receiver lines 504 and 540, with only the energy which corresponds to the same set of common midpoints shown for clarity. This set of common midpoints is shown in FIG. 5(d) as line 544. As the seismic survey progresses, more combinations of source positions and receiver positions add to the data corresponding to the common midpoints along line 544 shown. Other combinations of source positions along one or more source lines and a plurality of receiver lines allow the creation of common midpoint data sets at other common midpoints not shown in these figures.

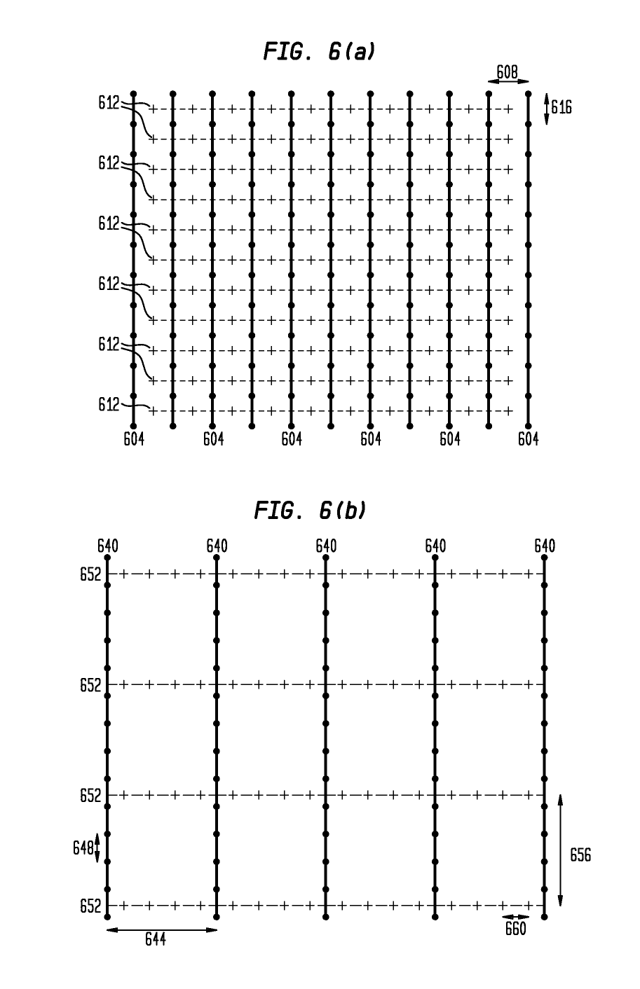

Referring now to FIG. 6(a), this shows an idealized geometry in which the spacing of a plurality of receiver lines 604 is equal to receiver station spacing 608 in the direction of the plurality of receiver lines 604. The spacing of a plurality of source lines 612 is also equal to source station spacing 616 in the direction of the plurality of source lines 612. There are advantages to having the receiver line spacing equal to the receiver spacing, including the ability to perform spatial filtering to eliminate noise from any direction. However, this configuration is rarely achieved or used in practice, as it requires a recording system capable of handling many channels of data simultaneously, or a system which stores the data at each receiver position for collection later. Setting out this number of receiver stations on the ground adds cost. Further, using so many source positions is very expensive. Surveying source positions before bringing in any equipment is time-intensive and costly. There are costs associated with the equipment, and clearing brush and undergrowth in order to place the sources and receivers. When explosive sources are used, there are costs associated with the explosives and the special facilities needed to store and transport them. Brush and undergrowth must be cleared to allow the passage of the trucks carrying the drills used to place explosive sources, and the trucks bringing in those explosive sources. Some of these costs can be mitigated by the efficient use of source positions. Other costs can be lowered by reducing the number of source positions. Drilling holes for the explosive charges adds to the cost. Truck-mounted vibrators are large vehicles, and often a path must be cleared so that they can reach the survey area in addition to clearing the actual source lines. In some seismic surveys, landowners demand a fee per shot. Remediation may be needed after the shots are fired or after the vibratory source trucks have traversed an area, thus adding more costs. Using fewer source positions decreases costs. Any reduction in the number of shots also results in reduced environmental impact.

Referring to FIG. 6(b), there is shown a more typical geometry for a survey using a plurality of parallel receiver lines 640 and a plurality of source lines 652 orthogonal to the receiver lines. Receiver line spacing 644 is much greater than receiver station spacing 648. Source line spacing 656 is also much greater than source station spacing 660.

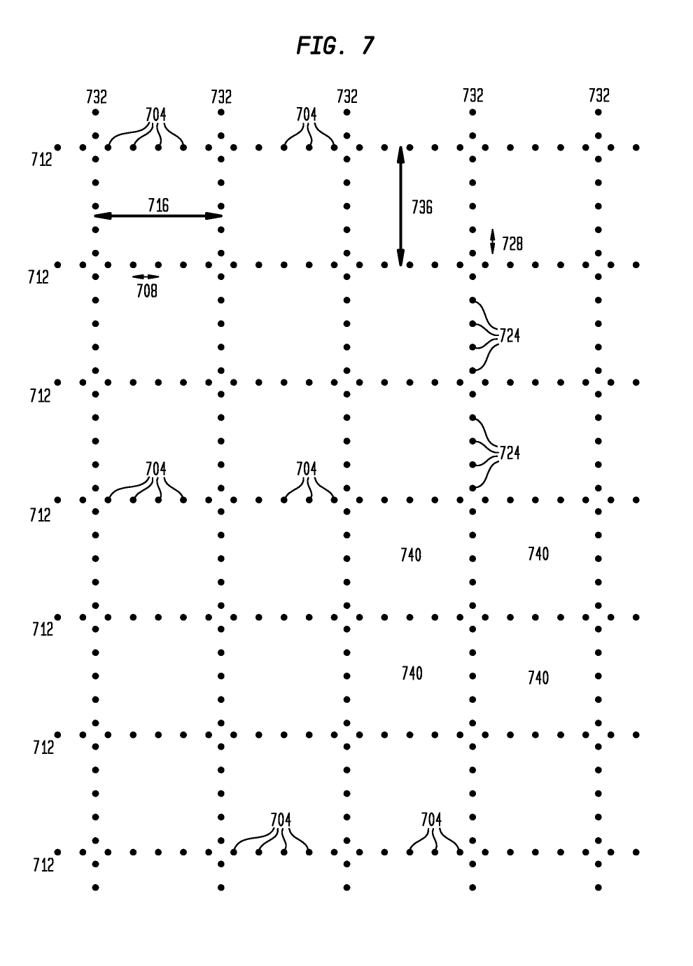

Referring now to FIG. 7, there is shown a receiver geometry for some embodiments. Source positions are not shown for clarity. The first plurality of receiver positions 704 is substantially equally spaced at first receiver spacing 708 along a first plurality of receiver lines 712, receiver lines 712 in the first plurality of receiver lines being substantially parallel to one another and substantially equally spaced from one another at first receiver line spacing 716. Also shown in FIG. 7 is a second plurality of receiver positions 724, the second plurality of receiver positions 724 being substantially equally spaced at second receiver spacing 728 along a second plurality of receiver lines 732. The receiver lines 732 in the second plurality of receiver lines are substantially parallel to one another and in some embodiments, substantially equally spaced from one another at second receiver line spacing 736. Receiver lines 732 in the second plurality of receiver lines are substantially orthogonal to receiver lines 712 in the first plurality of receiver lines. This creates grid 740 of receiver position rectangles. In some embodiments, the first plurality of receiver lines 712 and the second plurality of receiver lines 732 intersect at points equidistant from adjacent receiver positions, thereby maintaining the fold constant at the desired value.

In other embodiments, receiver lines 712 and 732 intersect at a common receiver position. This embodiment is less frequently used, because the same data are recorded on both receivers at the common receiver position, and the fold drops because the two receivers are essentially treated as one.

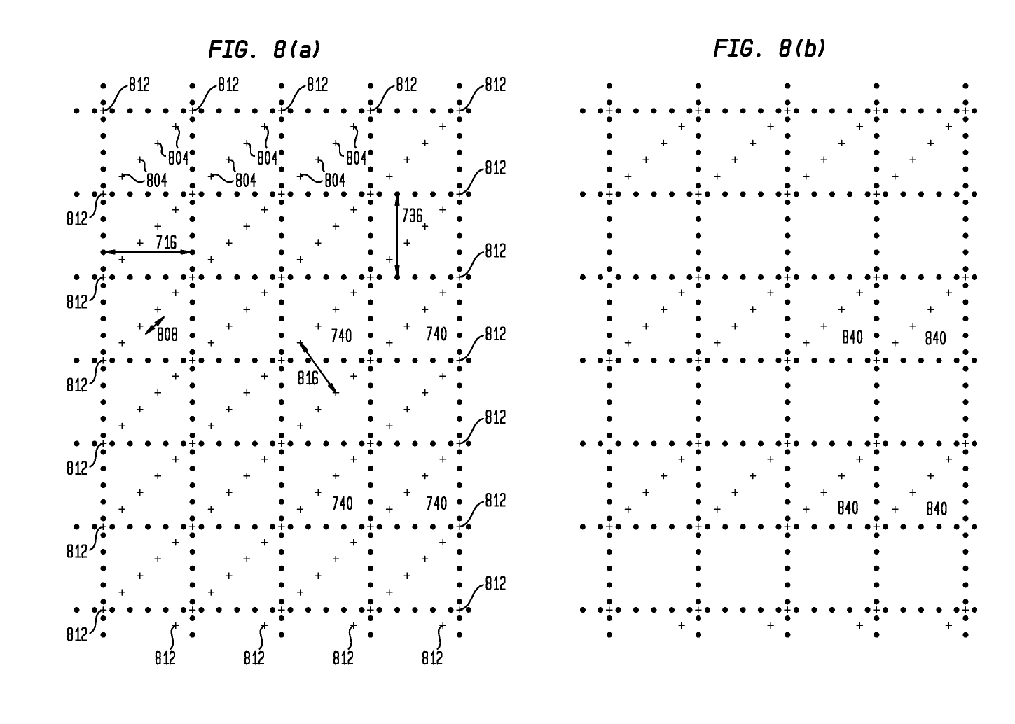

Referring to FIG. 8(a), there is shown an embodiment using a plurality of source positions 804, source positions 804 being substantially equally spaced at source position spacing 808. Source positions 804 are located along a plurality of source lines 812, source lines 812 being substantially parallel to one another. In some embodiments, source lines 812 are substantially equally spaced from one another at source line spacing 816. In other embodiments, source line spacing 816 may vary in a manner such that subsurface coverage remains within design requirements. In some embodiments, this source position geometry is combined with an orthogonal receiver position geometry as shown in FIG. 7, and as also shown in FIG. 8(a). According to some embodiments, the plurality of source lines 812 are substantially parallel to one of the diagonals of the grid 740 of rectangles formed by the first plurality of receiver lines 712 and the second plurality of receiver lines 732. In one embodiment where receiver line spacing 716 in the first plurality of receiver lines and receiver line spacing 736 in the second plurality of receiver lines are identical or substantially the same, the angle made by source lines 812 to each plurality of receiver lines 712 and 732 is 45 degrees. Other embodiments are possible in which the first plurality of receiver lines 712 have a different receiver line spacing 716 from the receiver line spacing 736 of the second plurality of receiver lines 732.

Still referring to FIG. 8(a), in some embodiments, data from the first plurality of receiver stations 704 and data from the second plurality of receiver stations 724 may be recorded using two separate data acquisition and recording systems 10, or in other embodiments, by one data acquisition and recording system 10.

Still referring to FIG. 8(a), the fold of the data detected by each plurality of receiver lines 712 and 732 can be computed from the geometry and spacing 816 of the source lines 812 and spacing 716 and 736 of the receiver lines 712 and 732. In some embodiments, data are not recorded from receiver positions proximate the source because the energy arriving directly at the receiver position from the shot along surface of the earth 14 overloads the receivers. According to other embodiments, data are not recorded from receiver positions, the distance of which from the shot exceeds some value beyond which useful data are not expected.

In some embodiments, the number of source positions used for generating seismic signals may be reduced while maintaining adequate subsurface coverage. FIG. 8(b) shows an embodiment wherein the number of source positions 804 at which the sources are activated on each source line 812 is reduced by activating sources only within alternating receiver position rectangles 840. Reducing the number of locations at which sources are activated reduces costs as described above, including the cost of each shot, remediation, per-shot fees, and other costs, and also reduces the time taken for the seismic survey.

As shown in FIGS. 8(a) and 8(b), detecting seismic signals using two different and orthogonal sets of receiver lines 712 and 732, is equivalent to simultaneously detecting seismic signals using two conventional independent sets of receiver lines such that the geophysical 3D design attributes from each conventional design are superimposed, but where each source position 804 is only used once. Using an orthogonal receiver array and diagonal source lines results in both cost savings and time savings. Eliminating the duplicate use of source positions results in substantial cost savings. Eliminating a second independent set of source positions for recording into the second set of receiver lines reduces costs yet further.

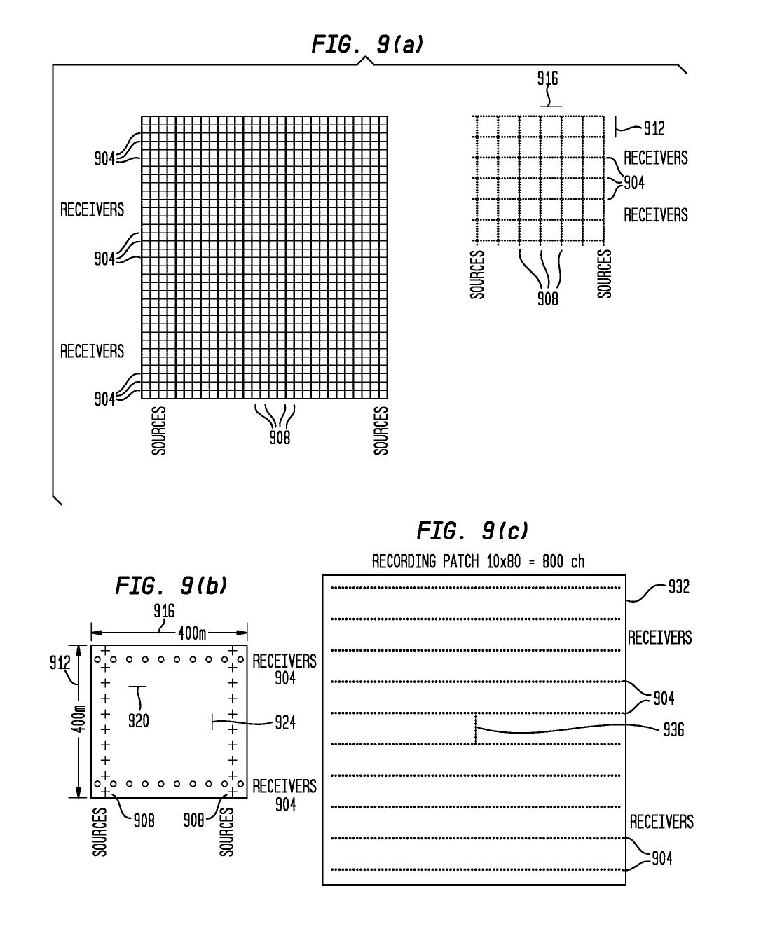

FIGS. 9-11 show examples of the computer generated diagrams used to calculate theoretical geometries for sources and receivers, which enables survey planners to compute the resulting fold and ensure adequate subsurface coverage.

Referring now to FIG. 9(a), there is shown a design for a seismic survey using an older orthogonal source-receiver design, with a plurality of substantially parallel receiver lines 904 substantially orthogonal to a plurality of substantially parallel source lines 908. 35 receiver lines 904 and 30 source lines 908 are surveyed. 8,120 receiver stations and 8,160 shots are required to complete the survey. Receiver line spacing 912 and source line spacing 916 are both about 400 meters. Receiver spacing 920 and source spacing 924 are both about 50 meters, as shown in FIG. 9(b) which depicts an enlarged version of one of the rectangles of FIG. 9(a) formed by receiver lines 904 and source lines 908.

In FIG. 9(c) there is shown recording patch 932. A “recording patch” is a subset of receiver stations connected to a data acquisition and recording system from which data are recorded for a given shot. Recording patch 932 connects 800 data channels to data acquisition and recording system 10 with eighty receivers connected from each of ten receiver lines 904. Other receivers are not connected to the data acquisition and recording system 10 for this shot. In the example shown, the shot location is on segment 936 of source line 908 at the center of recording patch 932. For clarity, only segment 936 of source lines 908 at the center of corresponding recording patch 932 is shown. As the shot position moves along source line 908, recording patch 932 is changed to include different receivers, such that the shot is always substantially proximate the center of recording patch 932, and the receivers connected to recording patch 932 are substantially symmetrically arranged about the location of the shot. For this array geometry, the fold is 25, the receiver station density is 50.82/km², and the source position density is about 50/km².

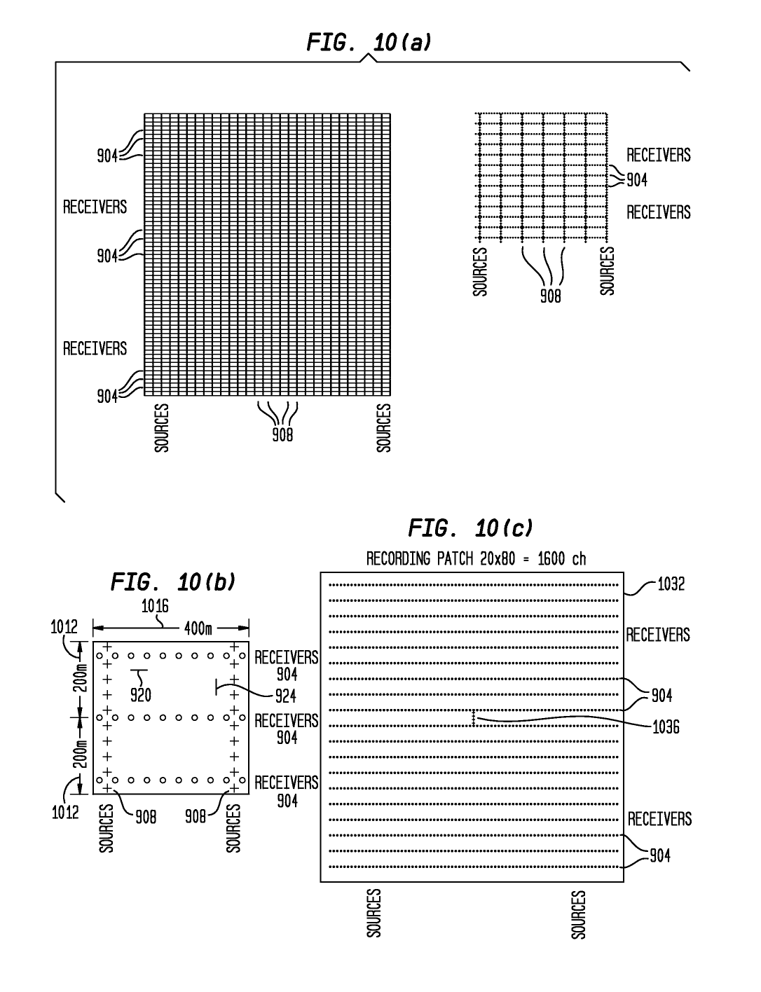

Referring now to FIG. 10(a), there is shown the same geometry as FIG. 9(a), still using an older orthogonal source-receiver design. but with receiver line spacing 1012 set at about 200 meters, or about one half of receiver line spacing 912 in FIG. 9(a). Source line spacing 1016 is the same as in FIG. 9(a) at about 400 meters. The number of receiver stations required to complete the survey is now 16,240, the number of shots is 8,280, and the fold increases to 50. FIG. 10(b) depicts an enlarged version of one of the rectangles of FIG. 10(a) formed by receiver lines 904 and source lines 908. Receiver spacing 920 and source spacing 924 are about 50 meters.

Referring now to FIG. 10(c), recording patch 1032 connects 1,600 data channels to data acquisition and recording system 10 in twenty lines of eighty receiver stations. Data acquisition and recording system 10 must be capable of recording twice as many channels as that required for the array of FIG. 9(a). The shot location is on segment 1036 of source line 908 at the center of recording patch 1032. For clarity, only segment 1036 of source lines 908 is shown. The receiver station density is about 100/km² and the source position density is about 50/km².

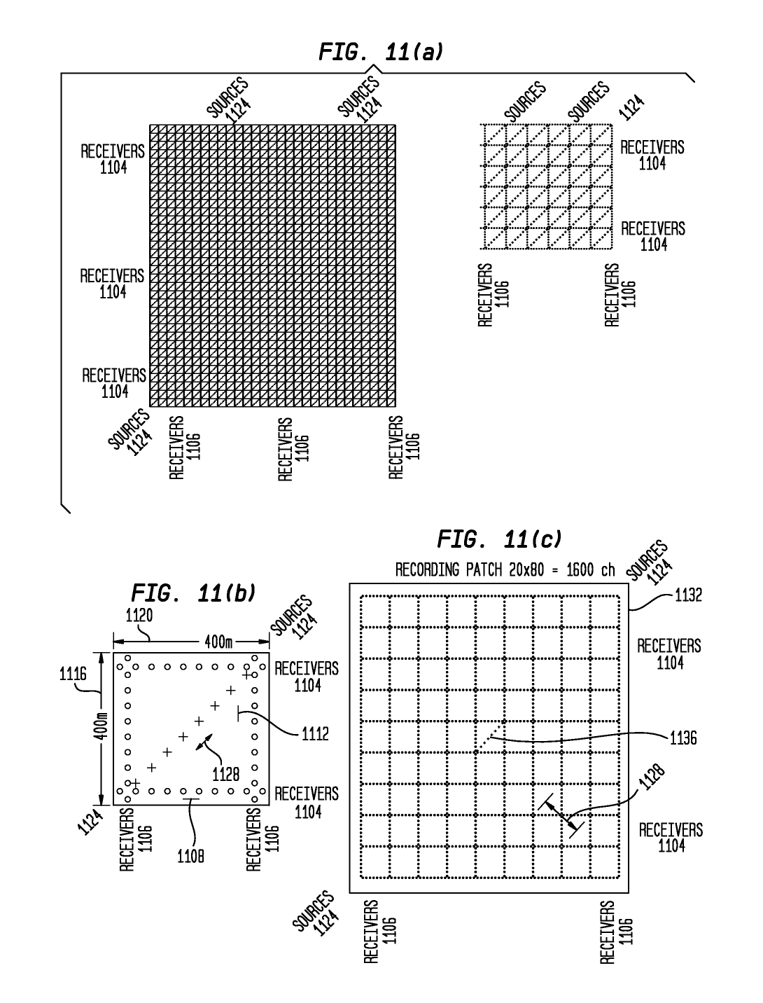

In FIG. 11(a) there is shown an embodiment of an orthogonal receiver array, that is, using two substantially orthogonal sets of substantially parallel receiver lines 1104 and 1106. Source lines 1124 are located along one diagonal of the squares made by the substantially orthogonal receiver lines. In other embodiments, where the receiver line spacing 1116 is not equal to the receiver line spacing 1120, source lines 1124 are located along one diagonal of the rectangles made by the substantially orthogonal receiver lines. Completion of the survey as shown in FIG. 11(a) requires 16,280 receiver positions and 7,888 source positions.

Referring now to FIG. 11(b), there is shown an enlarged version of one of the squares of FIG. 11(a) formed by mutually orthogonal receiver lines 1104 and 1106. Receiver spacing 1108 and 1112 are about 50 meters. Receiver line spacing 1116 for receiver lines 1104 and receiver line spacing 1120 for receiver lines 1106 are both about 400 meters. Source line spacing 1128 and source spacing 1140 may be computed from receiver line spacing 1116 and 1120 and receiver spacing 1108 and 1112.

Referring now to FIG. 11(c), there is shown recording patch 1132, which still uses 1,600 data channels. In this array, there are a total of twenty lines of eighty receiver stations with ten lines in each orthogonal direction. The shot 1136 is on one segment of source line 1124. For clarity, only segment 1136 of source lines 1124 is shown. The fold is about 50, the receiver station density is about 100/km², and the source position density is about 50/km². According to this embodiment, the statistics are similar to those for the geometry of FIG. 10(a). The decision as to which geometry is preferred depends on factors including ease of access, roads, tracks, and trails along which receiver lines may be positioned, and the availability of previously surveyed source and receiver lines.

In other embodiments, the seismic survey may be performed using a first plurality of substantially parallel source lines, a second plurality of substantially parallel source lines orthogonal to the first plurality of source lines, and a plurality of substantially parallel and substantially equally spaced receiver lines, the receiver lines being parallel to one of the diagonals of the rectangles formed by the first plurality of source lines and the second plurality of source lines. Such a geometry forgoes many of the cost advantages described above for the orthogonal receiver geometry. However, it may be used in special situations, for example when one set of receiver lines is already in place and there is a window of opportunity during which the data must be collected which does not allow time for more receivers to be set in place.

Another situation where such an embodiment proves useful is when the source lines must use existing roads, such as when a landowner will not permit the seismic vehicles to cross fields. Such circumstances are not unusual when the source is the large and heavy seismic vibrator truck, for example. As roads in rural areas are often arranged in an orthogonal grid pattern, using roads as source line locations and setting out receivers on the diagonals of this grid can achieve the required subsurface coverage.

Although the above description includes many specific examples, they should not be construed as limiting the scope of the invention, but rather as merely providing illustrations of some of the many possible embodiments of this method. The scope of the invention should be determined by the appended claims and their legal equivalents, and not by the examples given.

We claim:

1. A 3D seismic data acquisition array, comprising:
a plurality of source positions, the source positions being located along a plurality of source lines, the source lines being substantially parallel to one another;
a first plurality of receiver positions, the first plurality of receiver positions being substantially equally spaced at a first receiver spacing along a first plurality of receiver lines, the first plurality of receiver lines being substantially parallel to one another and substantially equally spaced from one another at a first receiver line spacing;
a second plurality of receiver positions, the second plurality of receiver positions being substantially equally spaced at a second receiver spacing along a second plurality of receiver lines, the second plurality of receiver lines being substantially parallel to one another and substantially equally spaced from one another at a second receiver line spacing;
wherein the receiver lines in the second plurality of receiver lines are substantially orthogonal to the receiver lines in the first plurality of receiver lines, and
the plurality of source lines are substantially parallel to one of the diagonals of the rectangles formed by the first plurality of receiver lines and the second plurality of receiver lines.

2. The array of claim 1, wherein the source lines are substantially equally spaced from one another.

3. The array of claim 1, wherein the receiver lines in the first plurality of receiver lines and the receiver lines in the second plurality of receiver lines intersect at points substantially equidistant from adjacent receiver positions in the first plurality of receiver lines and the second plurality of receiver lines.

4. The array of claim 1, wherein the spacing of the source positions in a direction parallel to the first plurality of receiver lines is a multiple or a fraction of the spacing of the receiver positions along the first plurality of receiver lines.

5. The array of claim 4, wherein the spacing of the source positions in a direction parallel to the second plurality of receiver lines is a multiple or a fraction of the spacing of the receiver positions along the second plurality of receiver lines.

6. The array of claim 1, wherein the source positions are substantially equally spaced along a plurality of segments of the plurality of source lines.

7. The array of claim 6, wherein segments of the plurality of source lines are omitted, the omitted segments corresponding substantially to alternate rectangles formed by the first plurality of receiver lines and the second plurality of receiver lines.

8. A method of performing a seismic survey, comprising:
generating seismic signals at a plurality of source positions, the source positions being located along a plurality of source lines, the source lines being substantially parallel to one another;
detecting the seismic signals at a first plurality of receiver positions, the first plurality of receiver positions being substantially equally spaced at a first receiver spacing along a first plurality of receiver lines, the first plurality of receiver lines being substantially parallel to one another and substantially equally spaced from one another at a first receiver line spacing;
detecting the seismic signals at a second plurality of receiver positions, the second plurality of receiver positions being substantially equally spaced at a second receiver spacing along a second plurality of receiver lines, the second plurality of receiver lines being substantially parallel to one another and substantially equally spaced from one another at a second receiver line spacing;
wherein the receiver lines in the second plurality of receiver lines are substantially orthogonal to the receiver lines in the first plurality of receiver lines, and
the plurality of source lines are substantially parallel to one of the diagonals of the rectangles formed by the first plurality of receiver lines and the second plurality of receiver lines.

9. The method of claim 8, wherein the source lines are substantially equally spaced from one another.

10. The method of claim 8, wherein the receiver lines in the first plurality of receiver lines and the receiver lines in the second plurality of receiver lines intersect at points equidistant from adjacent receiver positions in the first plurality of receiver lines and the second plurality of receiver lines.

11. The method of claim 8, wherein the spacing of the source positions in a direction parallel to the first plurality of receiver lines is a multiple or a fraction of the spacing of the receiver positions along the first plurality of receiver lines.

12. The method of claim 11, wherein the spacing of the source positions in a direction parallel to the second plurality of receiver lines is a multiple or a fraction of the spacing of the receiver positions along the second plurality of receiver lines.

13. The method of claim 8, wherein the source positions are substantially equally spaced along a plurality of segments of the plurality of source lines.

14. The method of claim 8, wherein segments of the plurality of source lines are omitted, the omitted segments corresponding substantially to alternate rectangles formed by the first plurality of receiver lines and the second plurality of receiver lines.

15. A method of performing a seismic survey, comprising:
generating seismic signals at a first plurality of source positions, the source positions being located along a first plurality of source lines at a first source position spacing, the source lines being substantially parallel to one another and substantially equally spaced from one another at a first source line spacing;
generating seismic signals at a second plurality of source positions, the source positions being located along a second plurality of source lines at a second source position spacing, the source lines being substantially parallel to one another and substantially equally spaced from one another at a second source line spacing, the source lines in the second plurality of source lines being substantially orthogonal to the source lines in the first plurality of source lines;
detecting the seismic signals at a plurality of receiver positions, the receiver positions being substantially equally spaced at a receiver spacing along a plurality of receiver lines, the plurality of receiver lines being substantially parallel to one another and substantially equally spaced from one another at a first receiver line spacing, and
the plurality of receiver lines being substantially parallel to one of the diagonals of the rectangles formed by the first plurality of source lines and the second plurality of source lines.
